(19) United States
(12) Patent Application Publication
(10) Pub. No.: US 2025/0091804 A1
(43) Pub. Date: Mar. 20, 2025

(54) Storage System

(71) Applicant: AutoStore Technology AS, Nedre Vats (NO)

(72) Inventor: Jørgen Djuve Heggebø, ØLEN (NO)

(21) Appl. No.: 18/727,783

(22) PCT Filed: Jan. 5, 2023
(86) PCT No.: PCT/EP2023/050167

§ 371 Date: Jul. 10, 2024

(30) Foreign Application Priority Data
Jan. 11, 2022 (NO) 20220036

(51) Int. Cl. B65G 1/04; B65G 1/06; B65G 1/137

(52) U.S. Cl. CPC B65G 1/0464; B65G 1/065; B65G 1/137

(57) ABSTRACT

The present invention provides a storage system (1) comprising a framework structure (100) and at least one container handling vehicle (301), the framework structure comprises vertical column profiles (102) defining multiple storage columns (105) in which storage containers (106) are stored one on top of another in vertical stacks, the column profiles are interconnected at their upper ends by rails (110,111) forming a horizontal rail grid (108) upon which the container handling vehicle (301) may move in two perpendicular directions, the container handling vehicle arranged to retrieve storage containers (106) from the storage columns (105), store storage containers in the storage columns (105), and transport the storage containers on the framework structure, the container handling vehicle comprises a cantilevered section from which a lifting frame (2) is suspended, the lifting frame being configured to releasably attach to an upper section of a storage container (106) and arranged to be raised or lowered in order to raise or lower an attached storage container (106), wherein the storage system comprises at least one container rack column (6) comprising a container rack (7), the container rack comprises container supports (8) by which a plurality of storage containers (106a- 106l) can be supported one above another at vertically spaced storage levels, the container rack (7) is moveable relative to the container rack column (6) in a vertical direction between a lowest position and a plurality of container access positions, where at each of the container access positions a storage container supported at a corresponding storage level may be retrieved by the container handling vehicle.

### FIELD OF THE INVENTION

The present invention relates to a storage system comprising a container rack column from which high-demand storage containers may be retrieved.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 (i.e. vertical column profiles) and a storage volume comprising storage columns 105 arranged in rows between the upright members 102. In these storage columns 105 storage containers 106, also known as bins, are stacked one on top of one another to form stacks 107. The upright members 102 may typically be made of metal, e.g. extruded aluminium profiles.

The framework structure 100 of the automated storage and retrieval system 1 comprises a rail system 108 (i.e. a rail grid) arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers 106 during raising of the containers 106 out from and lowering of the containers 106 into the columns 105. The stacks 107 of containers 106 are typically self-supportive.

Each prior art container handling vehicle 201,301,401 comprises a vehicle body 201a, 301a, 401a and first and second sets of wheels 201b,201c,301b,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c, 301c, 401c is arranged to engage with two adjacent rails of the second set 111 of rails. At least one of the sets of wheels 201b, 301b,201c, 301c, 401b, 401c can be lifted and lowered, so that the first set of wheels 2016, 301b, 401b and/or the second set of wheels 201c, 301c,401c can be engaged or disengaged with their respective set of rails 110, 111.

Each prior art container handling vehicle 201,301,401 also comprises a lift device 404, see FIG. 4, for vertical transportation of storage containers 106 (i.e. a container lift device), e.g. raising a storage container 106 from, and lowering a storage container 106 into, a storage column 105. The lift device 404 features a lifting frame 2 comprising container connectors 3, adapted to engage connecting recesses 19 at an upper rim 16 (i.e. upper section) of the sidewalls 14 of a storage container 106, see FIG. 5, and guiding pins 4. The guiding pins 4 are arranged to interact with guiding pin recesses 18 at the corners of the storage container and ensure a correct alignment of the lifting frame 2 and container connectors 3 relative to the storage container. The guiding pins 4 will also assist in guiding the lifting frame 2 relative to the upright members of the storage column 105. The lifting frame 2 can be lowered from the vehicle 201,301,401 so that the position of the lifting frame 2 with respect to the vehicle 201,301,401 can be adjusted in a third direction Z which is orthogonal the first direction X and the second direction Y. The lifting device of the container handling vehicle 201 is located within the vehicle body 201a in FIG. 2.

To raise or lower the lifting frame 2 (and optionally a connected storage container 106), the lifting frame 2 is suspended from a band drive assembly by lifting bands 5. In the band drive assembly, the lifting bands are commonly spooled on/off at least one rotating lifting shaft or reel arranged in the container handling vehicle. Various designs of band drive assemblies are described in for instance WO 2015/193278 A1, WO 2017/129384 A1 and WO 2019/206438 A1.

Conventionally, and also for the purpose of this application, Z=1 identifies the uppermost layer for storing storage containers below the rail system 108, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. The lifting frame 2 is suspended from a cantilevered section 15 of the container handling vehicle 301. Such a vehicle is described in detail in e.g. U.S. Pat. No. 317,366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, each rail may comprise two parallel tracks, or the rail system may comprise one track rails in one direction and two track rails in the other direction. Each rail may comprise a pair of track members, each track member being provided with a single track, the pair of track members being fastened together to provide a rail in a given direction.

WO2018/146304A1, the contents of which are incorporated herein by reference, illustrates a typical configuration of rail system 108 comprising rails and parallel tracks in both X and Y directions forming a rail grid.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the storage columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 404, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

The requirement of “digging”, when a storage container to be retrieved is located deep within a stack, may in some cases entail a less than optimum time efficiency and utility of the container handling vehicles of the storage system. This may be an issue when items in high demand are distributed over a large number of storage containers.

An object of the present invention is to provide an improved storage system, wherein an increased number of storage containers may be retrieved in a more time-efficient manner.

### SUMMARY OF THE INVENTION

The present invention is defined by the attached claims and in the following:

In a first aspect, the present invention provides a storage system comprising a framework structure and at least one container handling vehicle, the framework structure comprises vertical column profiles defining multiple storage columns in which storage containers are stored one on top of another in vertical stacks, the column profiles are interconnected at their upper ends by rails forming a horizontal rail grid upon which the container handling vehicle may move in two perpendicular directions, the container handling vehicle arranged to retrieve storage containers from the storage columns, store storage containers in the storage columns, and transport the storage containers on the framework structure, the container handling vehicle comprises a cantilevered section from which a lifting frame is suspended, the lifting frame being configured to releasably attach to an upper section of a storage container and arranged to be raised or lowered in order to raise or lower an attached storage container,
wherein
the storage system comprises at least one container rack column comprising a container rack, the container rack comprises container supports by which a plurality of storage containers can be supported one above another at vertically spaced storage levels, the container rack is moveable relative to the container rack column in a vertical direction between a lowest position and a plurality of container access positions, where at each of the container access positions a storage container supported at a corresponding storage level may be retrieved by the container handling vehicle.

When the container rack is in an upper container access position, the container handling vehicle may retrieve a storage container supported in a lowermost storage level.

When the container rack is in one of the plurality of container access positions, the distance from an upper section of a storage container, arranged at a corresponding storage level, to a bottom of a storage container arranged at a storage level adjacently above the corresponding storage level, is sufficient to allow the cantilevered section to extend into the container rack above the storage container.

When the container rack is in a specific container access position, a container handling vehicle may retrieve a storage container supported at the corresponding storage level or store a storage container at the corresponding storage level.

In an embodiment of the storage system, the container rack may be configured to allow the cantilevered section and the lifting frame of the container handling vehicle to extend into the container rack above a storage container supported at a storage level within the container rack, when the container rack is raised to a corresponding container access position, such that the supported storage container may be retrieved.

In an embodiment of the storage system, each of the container access positions may provide access for the container handling vehicle to a corresponding storage level of the container rack.

In an embodiment, the storage system may comprise an actuator, the actuator being configured to move the container rack between the lowest position and any of the container access positions. The actuator may be arranged within the container rack column, below and/or at a side of the container rack. The actuator may comprise any type of actuator suitable for moving the container rack in a vertical direction, including a rack/pinion mechanism, hydraulic pistons or electric linear actuators.

In an embodiment of the storage system, the actuator is a lift configured to push the container rack from the lowest position to any of the container access positions.

In an embodiment of the storage system, the lift may be arrangeable below the container rack.

In an embodiment, the storage system may comprise a first container rack column and a second container rack column, and the actuator may be moved in a horizontal direction between a position below a container rack in the first container rack column to a position below a container rack in the second container rack column.

In an embodiment of the storage system, the container rack column is defined by four of the vertical column profiles.

In an embodiment of the storage system, the container supports comprise shelves, each shelf defining a separate storage level.

In an embodiment of the storage system, a top section of the container rack is at a level above the rail grid when the container rack is in any of the container access positions.

In an embodiment of the storage system, the top section may comprise rail portions, the rail portions forming a part of the rail grid when the container rack is in the lowest position.

When the rail grid comprises double track rails, the rail portions may have a width corresponding to the width of one of the tracks.

In an embodiment of the storage system, a vertical distance between at least two of the container supports may increase during movement of the container rack from the lowest position to one of the container access positions.

In an embodiment of the storage system, the container rack may comprise vertical rack profiles to which the container supports are coupled or connected. The rack profiles may have any suitable shape for providing a rack, such as beams or plates.

In an embodiment of the storage system, the container supports may be coupled or connected to the vertical rack profiles, such that the distance between at least two storage levels increases when the container rack is moved from the lowest position to one of the container access positions.

In an embodiment of the storage system, at least one of the container supports may be fixed relative to the vertical rack profiles, by mechanical stops or electronically controlled fasteners/brakes, during vertical movement of the rack profiles.

In an embodiment of the storage system, at least one of the container supports may be fixed at two different levels relative to the vertical rack profiles, a first level when the container rack is in the lower position and a second level when the container rack is in a container access position (i.e. in the container access position wherein the container handling vehicle may retrieve a storage container supported by the at least one container support fixed at the second level), wherein the at least one container support may be fixed at least at the second level by mechanical stops or electronically controlled fasteners/brakes.

In an embodiment of the storage system, a first container support may be arranged to support a first storage container at a first storage level and a second container support may be arranged to support a second storage container at a second storage level, and the container rack is configured such that the vertical distance between the first and the second container support will increase when the container rack is moved from the lowest position to a container access position in which the first storage container may be retrieved from the first storage level by the container handling vehicle.

In an embodiment of the storage system, the container rack may support a first storage container at a first storage level and a second storage container at a second storage level, the first storage level arranged below the second storage level. The container rack may move to a first container access position and a second container access position, in the first container access position, a storage container may be retrieved from or stored at the first storage level by the container handling vehicle, and in the second container access position, a storage container may be retrieved from or stored at the second storage level by the container handling vehicle.

In a second aspect, the present invention provides a method of improving access to a storage container in a storage system according to any embodiment of the first aspect, the method comprising the steps of:
identifying the storage container stored in one of the storage columns;
retrieving the storage container from the storage column by use of the container handling vehicle;
moving the container rack to a container access position, wherein the corresponding storage level is available (or the container supports at the corresponding storage level is available);
moving the container handling vehicle to the container rack;
extending the cantilever section and the lifting frame of the container handling vehicle into the container rack; and
depositing the storage container at the available storage level.

The method may be used to improve access to a high-demand storage container. In other words, the storage container may be a high-demand storage container. A high-demand storage container may be a storage container in which items of high demand are stored. High-demand storage containers may be storage containers which are retrieved more often than an average retrieval rate of the total storage containers in the storage system.

In a third aspect, the present invention provides a method of retrieving a storage container in a storage system according to any embodiment of the first aspect, the method comprising the steps of:
identifying the container rack and storage level at which the storage container is stored;
moving the identified container rack to a container access position, wherein the storage container is supported at the corresponding storage level;
moving the container handling vehicle to the container rack;
extending the cantilever section and the lifting frame of the container handling vehicle into the container rack; and
retrieving the storage container.

In a fourth aspect, the present invention provides a storage system comprising a framework structure and at least one container handling vehicle, the framework structure comprises vertical column profiles defining multiple container rack columns, each column comprising a container rack, the container rack comprises container supports by which a plurality of storage containers can be supported one above another at vertically spaced storage levels, the container rack is moveable relative to the container rack column in a vertical direction between a lowest position and a plurality of container access positions, the column profiles are interconnected at their upper ends by rails forming a horizontal rail grid upon which the container handling vehicle may move in two perpendicular directions, the container handling vehicle arranged to retrieve storage containers from the container rack columns, store storage containers in the container rack columns, and transport the storage containers on the framework structure, the container handling vehicle comprises a cantilevered section from which a lifting frame is suspended, the lifting frame being configured to releasably attach to an upper section of a storage container and arranged to be raised or lowered in order to raise or lower an attached storage container, wherein
at each of the container access positions a storage container supported at a corresponding storage level may be retrieved by the container handling vehicle.

The storage system according to the fourth aspect may comprise the features of any of the embodiments of the storage system according to the first aspect.

### BRIEF DESCRIPTION OF THE DRAWINGS

Embodiments of the invention is described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 is a perspective view of a prior art container handling vehicle, wherein a container lifting assembly is shown.

FIG. 5 is a perspective view of a prior art storage container as used in the storage system in FIG. 1.

FIGS. 6-8 are perspective views of a first exemplary embodiment of a storage system according to the invention.

FIGS. 9-14 are perspective and side views of a second exemplary embodiment of a storage system according to the invention.

FIGS. 15-16 are perspective views of a third exemplary embodiment of a storage system according to the invention.

### DETAILED DESCRIPTION OF THE INVENTION

In the following, embodiments of the invention will be discussed in more detail by way of example only and with reference to the appended drawings.

The invention provides a storage system in which the retrieval of storage containers accommodating items of high demand may be accessed more efficiently. Such storage containers may also be termed high-demand storage containers. High-demand storage containers are storage containers which are retrieved from the storage system more often than the average storage container. In other words, a high-demand storage container has a retrieval rate being higher than the average retrieval rate of the storage containers.

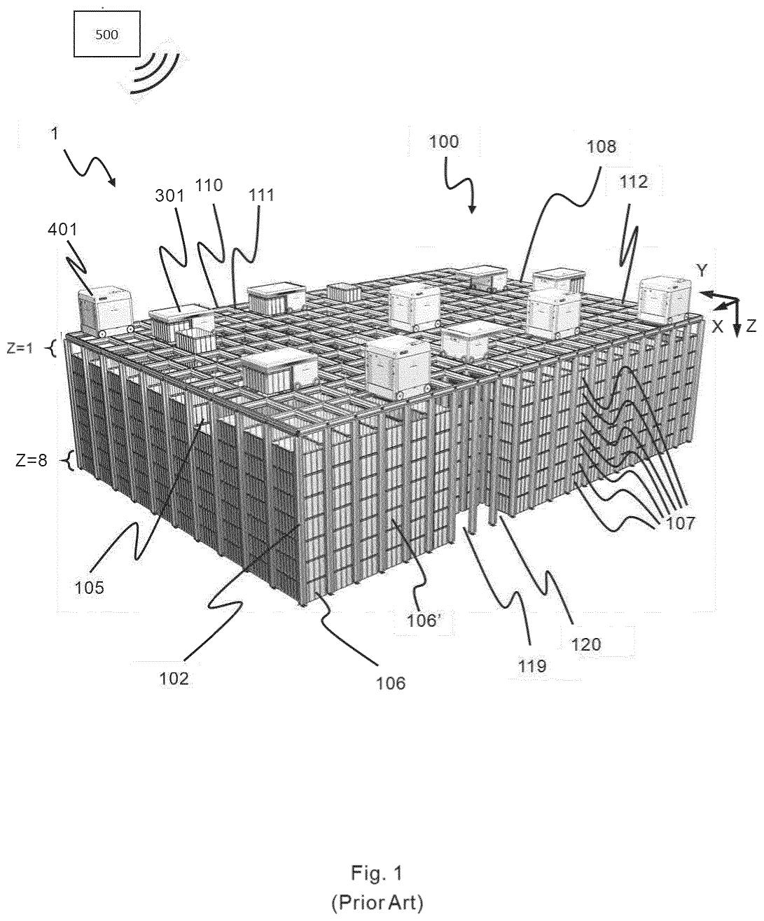

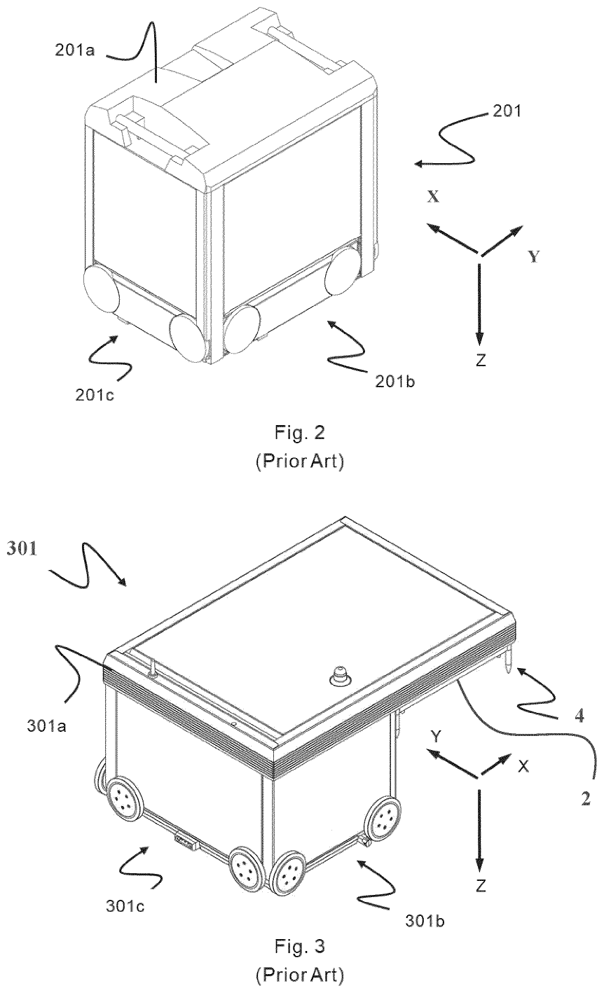

The inventive storage system is based on prior art storage systems 1, see FIGS. 1-5, as described in the background section above.

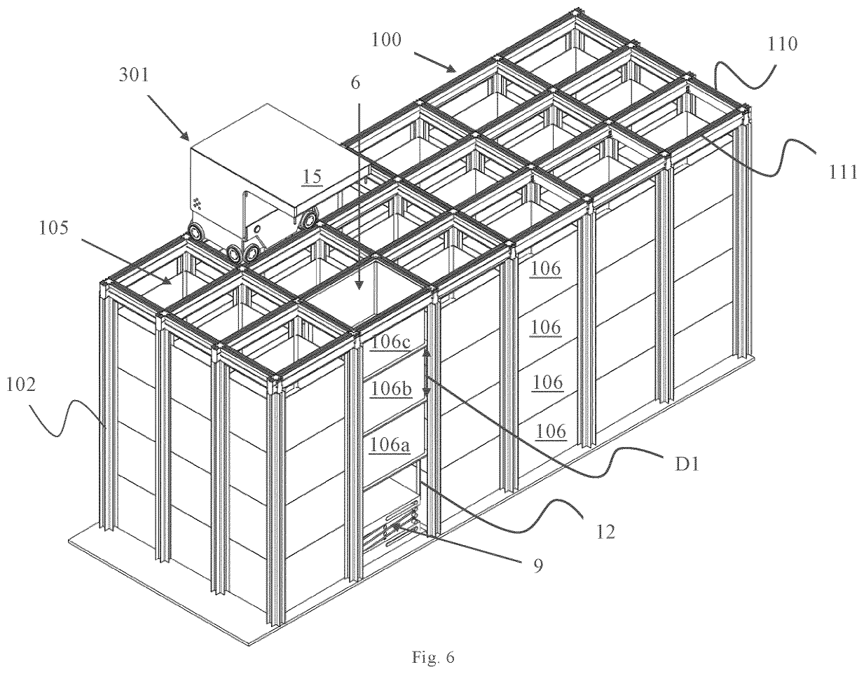

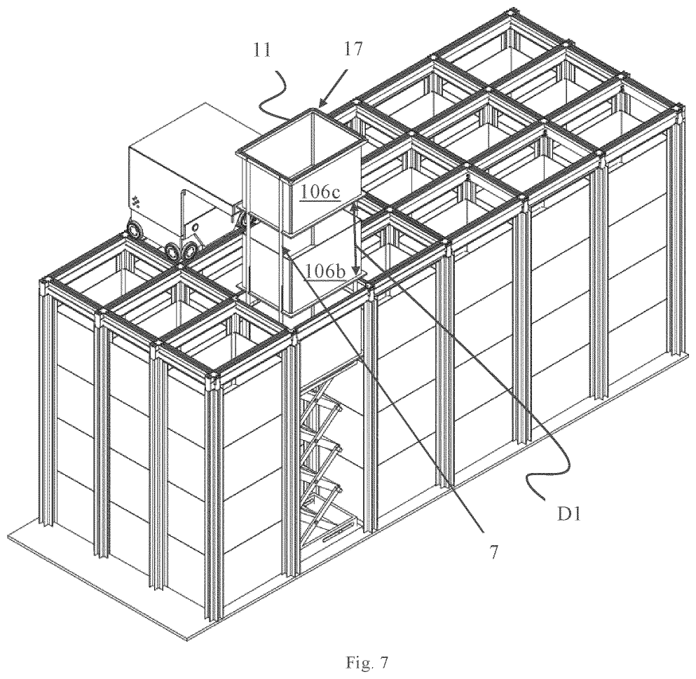

FIGS. 6-8 disclose a first exemplary embodiment of a storage system according to the invention. The storage system comprises a framework structure 100 and at least one container handling vehicle 301. Like the prior art storage system in FIG. 1, the framework structure 100 comprises vertical column profiles 102 (i.e. upright members) defining a plurality of storage columns 105. In the storage columns 105, storage containers 106 are stored one on top of another in vertical stacks.

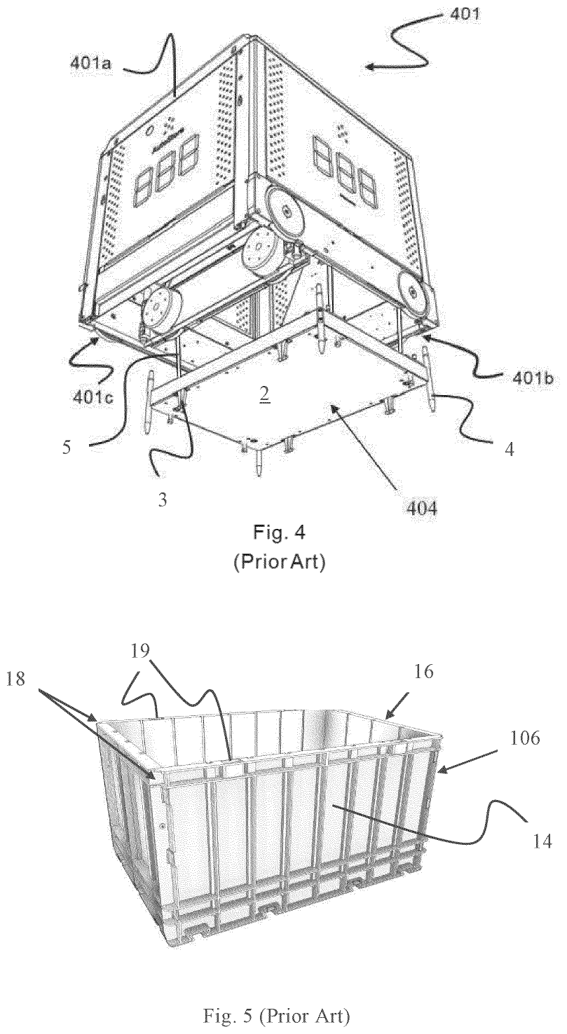

The column profiles 102 are interconnected at their upper ends by rails 110,111 forming a horizontal rail grid 108 upon which the container handling vehicle 301 may move in two perpendicular directions. The container handling vehicle 301 is arranged to retrieve storage containers 106 from the storage columns 105, store storage containers 106 in the storage columns 105 and transport the storage containers 106 on the framework structure 100. The container handling vehicle 301 comprises a cantilevered section 15 from which a lifting frame 2 is suspended, see FIG. 3. The lifting frame 2 is configured to releasably attach to an upper section 16 of a storage container 106, see FIG. 5, and arranged to be raised or lowered to raise or lower an attached storage container 106.

In addition to the storage columns 105, the storage system comprises at least one container rack column 6. The container rack column 6 features a container rack 7 having shelves 8 (i.e. container supports). The shelves 8 allow a plurality of storage containers 106a-106f to be supported one above another at vertically spaced storage levels. The container rack 7 is moveable relative to the container rack column 6 in a vertical direction between a lowest position and a plurality of container access positions, where at each of the container access positions a storage container 106 supported at a corresponding storage level may be retrieved by the container handling vehicle 301. In FIG. 8, the container rack is in the container access position which allows the container handling vehicle to retrieve the storage container 106b arranged at the storage level corresponding to said container access position.

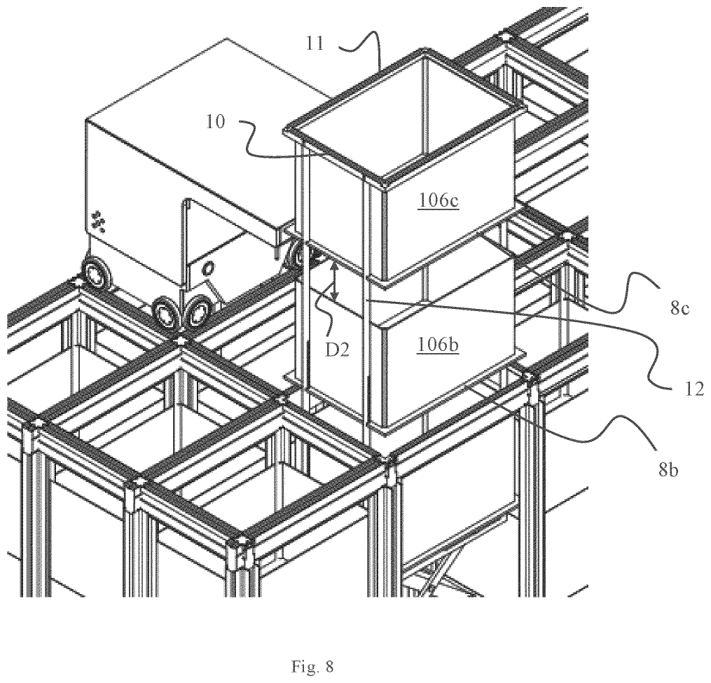

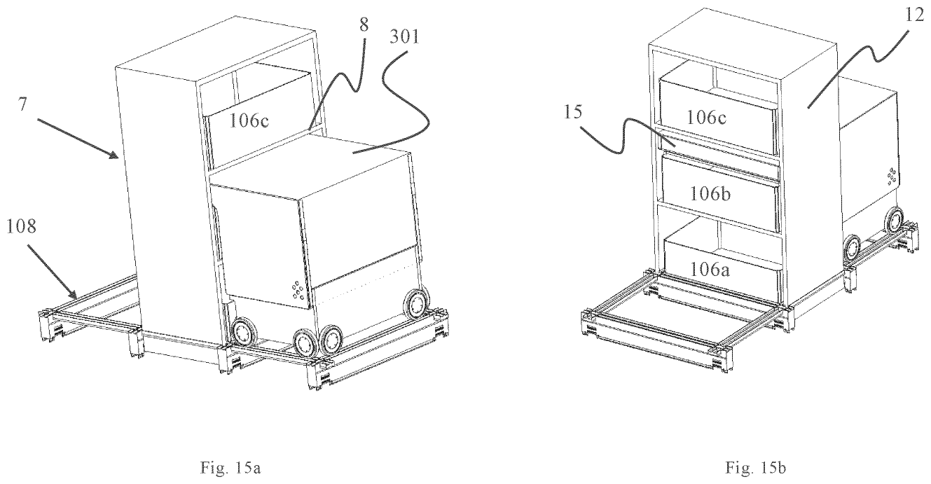

The container rack 7 is configured to allow the cantilevered section 15 and lifting frame 2 of the container handling vehicle 301 to extend into the container rack 7 above a storage container 106b, see FIGS. 7 and 15b, which is supported at a storage level within the container rack 7, when the container rack 7 has been raised to a corresponding container access position. In this manner the supported storage container 106b may be retrieved from the storage rack 7 by the container handling vehicle.

When the container rack 7 is in a container access position, the vertical distance D1 between two vertically adjacent shelves 8b,8c, see FIGS. 7 and 8, is such that the vertical distance D2 from an upper section 16 of a storage container 106b, arranged at the lower shelf 8b (i.e. at the corresponding storage level of the container access position), to a bottom section of a storage container 106c, arranged at the upper shelf 8c (i.e. at a storage level adjacently above the corresponding storage level), is sufficient to allow the cantilevered section 15 to extend between the upper section and the bottom section.

The container rack column 6 features a lift 9 (i.e. an actuator) configured to push the container rack 7 from the lowest position to any of the container access positions. In case of a storage system 1 featuring a plurality of container rack columns 6, the lift 9 may be moveable between the container rack columns 6, such that a single lift 9 may be used to push any container rack 7 of a plurality of container racks 7.

All storage containers 106 of the inventive storage system are similar in the sense that they may be stored in any the container rack 7 or one of the storage columns 105. All of the storage containers may advantageously be similar to the the prior art storage container in FIG. 5.

In other embodiments, the container rack 7 may be moved from the lowest position to any of the container access positions by any suitable type of actuator, including a rack/pinion mechanism, hydraulic pistons or electric linear actuators. An actuator may also be arranged in a framework above the container rack 7 and the rail grid 108. However, such a solution may in many cases be disadvantageous since it will prevent movement of the container handling vehicle 301 above the container rack column 6 when the container rack 7 is in the lowest position.

The container rack 7 comprises a set of vertical rack profiles 12 to which the shelves are coupled. In the first embodiment, the uppermost shelf is fixed to the rack profiles 12. A downwards movement of the remaining shelves 8 relative to the rack profiles 12 are restricted by stops fixed to the rack profiles 12 (the stops are not visible in the drawings but may e.g. be protrusions extending under the shelves 8). The stops define storage levels of the container rack 7. When the lift pushes the rack profiles 12, the shelf 8 supporting the upper storage container 106c follows the initial movement of the rack profile 12 while the remaining shelves remains in place. When the rack profiles have moved an initial distance at least equal to the height D2 required for the cantilevered section to be inserted above a storage container, the remaining shelves 8 interact with the stops on the rack profile such that they move along with the rack profile separated by the required height. In this manner the space occupied by the storage containers 106a-106c when the container rack 7 is in the lowest position is reduced while a required distance between the storage containers are provided when the container rack 7 is in any of the container access positions. The storage container 106c in the uppermost storage level may be retrieved in the same manner as the upper storage containers in the storage columns 105.

To obtain an optimum integration of the container rack column 6 into the storage system, an upper end (i.e. top section) of the container rack 7 comprises rail portions 10,11. The rail portions constitutes a part of the rail grid 108 when the container rack 7 is in the lowest position. The rail portions 10,11 allow for the positioning of a container rack column 6 at any position within the storage system without compromising the movement paths of the container handling vehicles 301 of the container handling vehicles on the rail grid 108 when the container rack 7 is in the lowest position. When the rail grid 108 comprises double track rails, the rail portions 10,11 may have a width corresponding to the width of one of the tracks.

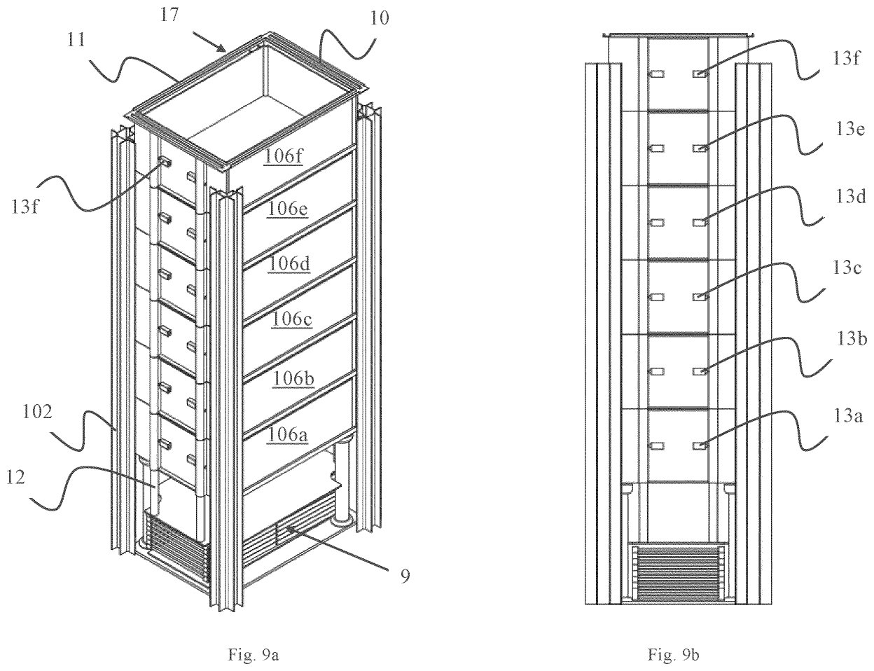

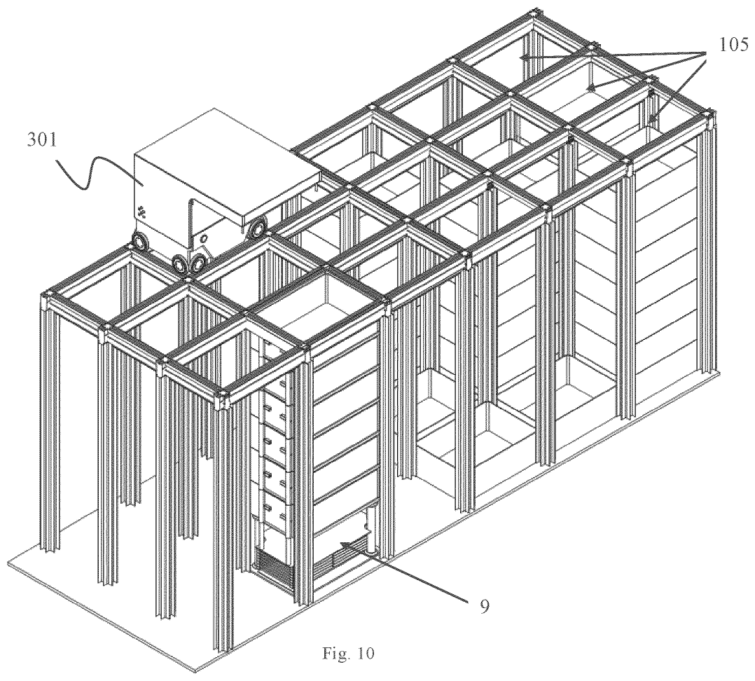

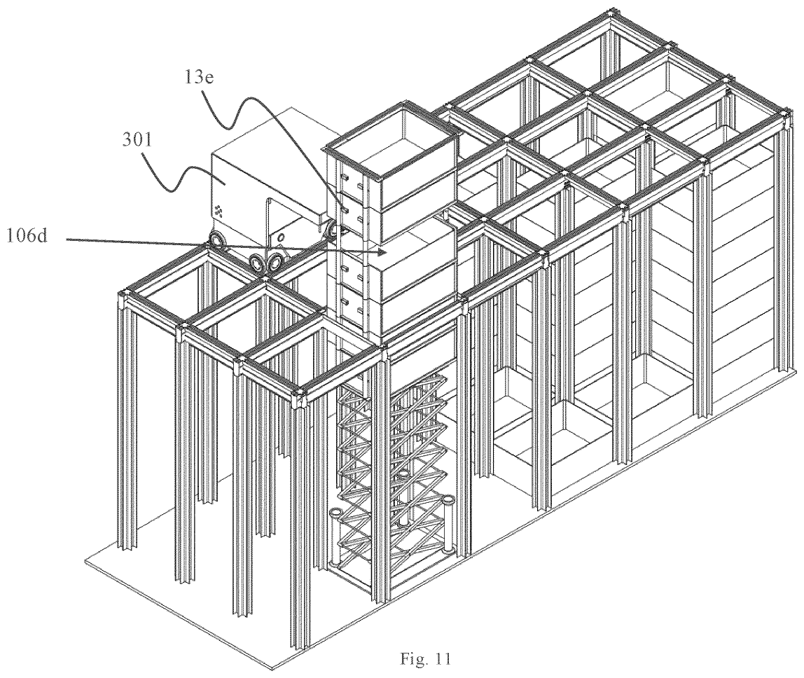

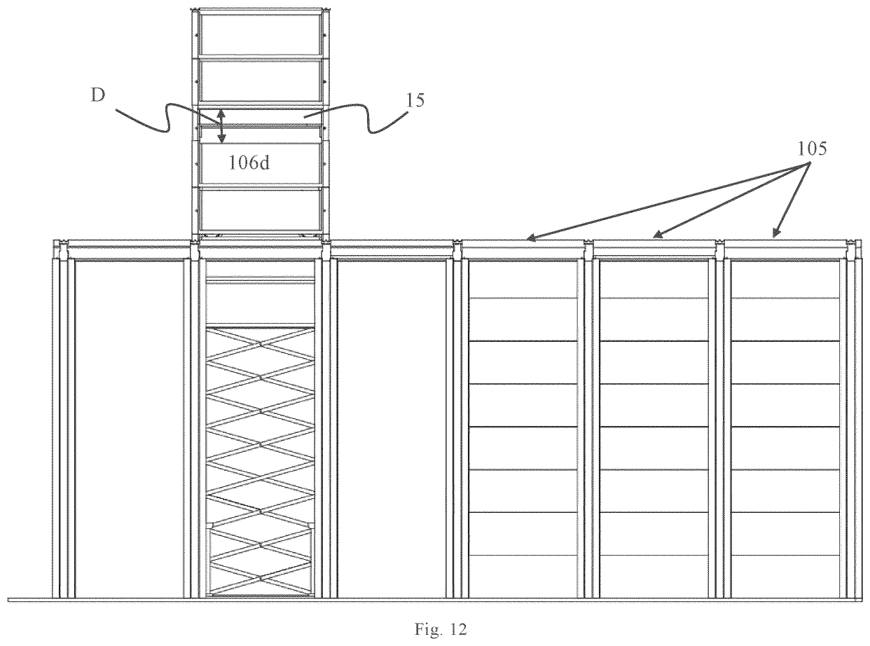

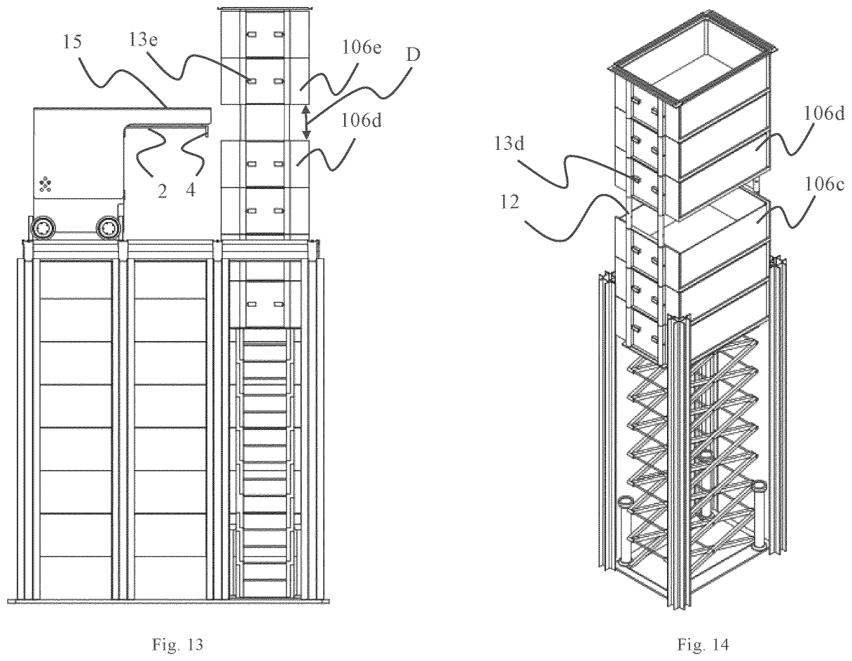

FIGS. 9-14 disclose a second exemplary embodiment of the invention, wherein the container rack column 6 may store storage containers 106a-106f in an even more compact manner than in the first exemplary embodiment. The solution is similar to the one in FIGS. 6-8, but each shelf 8 is coupled to the rack profiles by electronically controlled locking pins 13a-13f (i.e. fasteners/brakes). For instance, when storage container 106d is to be retrieved, at least the locking pins 13e of the shelf 8 above the storage container 106d, i.e. the shelf 8 supporting storage container 106e, are activated and fixed to the rack profiles 12. The locking pins 13a-13d are not activated and allows the vertical profiles 12 to move relative to the shelves 8 supporting the lower storage containers 106a-106d. In this manner, the shelf 8 supporting storage container 106e follows the movement of the rack profile 12 during the vertical movement from the lowest position to the selected container access positions. After a minimum distance D1, the lowest shelf 8 is pushed by the lift 9 and the storage containers 106a-106d follow the same vertical movement as the rack profiles 12 keeping the required distance D between the storage containers 106d and 106e. The distance D1 is at least equal to the height of the cantilevered section 15 of the container handling vehicle 301 including the lifting frame 2 and guiding pins 4. Depending on which of the locking pins 13a-13f are activated, more than one of the storage levels may be accessible by the container handling vehicle 301 at a corresponding container access position. In this manner, the container handling vehicle 301 may store a storage container at an available storage level and subsequently retrieve a storage container from another storage level without having to lower the container rack to its lowest position in an intermediate step.

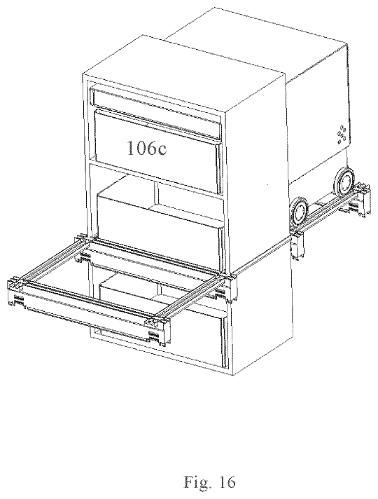

FIGS. 15 and 16 disclose a third exemplary embodiment of the invention. The drawings show only a section of a rail grid 108, a container rack 7 and a container handling vehicle 301. In this embodiment, the shelves 8 are arranged at fixed levels relative to the rack profiles 12, such that all storage containers are at a required vertical distance to allow the cantilevered section to extend inside the container rack 7 above the storage container to be retrieved. The construction of the container rack is simpler than for the first and second exemplary embodiment, but the storage capacity is somewhat lower. Similar to the embodiments in FIGS. 6-14, the third embodiment features a lift (not shown) arranged to move the container rack 7 between a lowest position and a plurality of container access position, and may advantageously feature rail portions 10,11 (not shown) at a top section thereof.

The storage system according to the invention allows for advantageous methods of improving access to a storage container. An exemplary method may comprise the following steps:
identifying the storage container 106 stored in one of the storage columns 105;
retrieving the storage container from the storage column by use of the container handling vehicle 301;
moving the container rack 7 to an access position, wherein the corresponding storage level is available;
moving the container handling vehicle to the container rack 7;
extending the cantilever section 15 and the lifting frame 2 of the container handling vehicle 301 into the container rack 7; and
depositing the storage container at the available storage level.

The exemplary method may for instance be used to move a high-demand storage container from within a storage column 105 to a more easily accessible storage position in a container rack column 6.

The framework structure of other exemplary storage systems may predominantly comprise container rack columns, optionally in combination with a few storage column in which storage containers are stored on top of another in stacks, each container rack column featuring a container rack. Such storage systems may be advantageous in smaller storage systems in which most of the stored items have a high turnover.

### LIST OF REFERENCE NUMBERS

1 Prior art automated storage and retrieval system
2 Lifting frame
3 Container connector
4 Guiding pin
5 Lifting band
6 Container rack column
7 Container rack
8 Container support, shelf
9 Actuator, lift
10 Rail portion, X-direction of rail grid
11 Rail portion, Y-direction of rail grid
12 Rack profile
13 Locking pin
14 Sidewall of storage container
15 Cantilevered section of container handling vehicle
16 Upper rim, upper section of storage container
17 Top section of container rack
18 Guiding pin recess
19 Connecting recess
100 Framework structure
102 Upright members of framework structure
103 Horizontal members of framework structure
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
Y Second direction
Z Third direction

1. A storage system (1) comprising a framework structure (100) and at least one container handling vehicle (301), the framework structure comprises vertical column profiles (102) defining multiple storage columns (105) in which storage containers (106) are stored one on top of another in vertical stacks, the column profiles are interconnected at their upper ends by rails (110,111) forming a horizontal rail grid (108) upon which the container handling vehicle (301) may move in two perpendicular directions, the container handling vehicle arranged to retrieve storage containers (106) from the storage columns (105), store storage containers in the storage columns (105), and transport the storage containers on the framework structure, the container handling vehicle comprises a cantilevered section from which a lifting frame (2) is suspended, the lifting frame being configured to releasably attach to an upper section of a storage container (106) and arranged to be raised or lowered in order to raise or lower an attached storage container (106),
wherein
the storage system comprises at least one container rack column (6) comprising a container rack (7), the container rack comprises container supports (8) by which a plurality of storage containers (106a-106f) can be supported one above another at vertically spaced storage levels, the container rack (7) is moveable relative to the container rack column (6) in a vertical direction between a lowest position and a plurality of container access positions, where at each of the container access positions a storage container supported at a corresponding storage level may be retrieved by the container handling vehicle.

2. The storage system according to claim 1, wherein the container rack (7) is configured to allow the cantilevered section and lifting frame (2) of the container handling vehicle to extend into the container rack (7) above a storage container (106), which is supported at a storage level within the container rack (7), when the container rack is raised to a corresponding container access position, such that the supported storage container may be retrieved.

3. The storage system according to claim 1, comprising an actuator, the actuator being configured to move the container rack (7) between the lowest position and any of the container access positions.

4. The storage system according to claim 3, wherein the actuator is a lift (9) configured to push the container rack (7) from the lowest position to any of the container access positions.

5. The storage system according to claim 4, wherein the lift is arrangeable below the container rack.

6. The storage system according to claim 1, wherein the container rack column (6) is defined by four of the vertical column profiles (102).

7. The storage system according to claim 1, wherein the container supports comprise shelves (8), each shelf defining a separate storage level.

8. The storage system according to claim 1, wherein a top section (17) of the container rack (7) is at a level above the rail grid (108) when the container rack is in any of the container access positions.

9. The storage system according to claim 8, wherein the top section (17) comprises rail portions (10,11), the rail portions forming a part of the rail grid (108) when the container rack (7) is in the lowest position.

10. The storage system according to claim 1, wherein a vertical distance (D1) between at least two of the container supports (8) increases during movement of the container rack (7) from the lowest position to one of the container access positions.

11. The storage system according to claim 1, wherein the container rack (7) comprises vertical rack profiles (12) to which the container supports (8) are coupled or connected.

12. The storage system according to claim 11, wherein the container supports (8) are coupled or connected to the vertical rack profiles (12), such that a distance between at least two storage levels increases when the container rack (7) is moved from the lowest position to one of the container access positions.

13. The storage system according to claim 11, wherein at least one of the container supports (8) may be fixed relative to the vertical rack profiles (12), by mechanical stops or electronically controlled fasteners/brakes (13), during vertical movement of the rack profiles (12).

14. The storage system according to claim 11, wherein at least one of the container supports (8) may be fixed at two different levels relative to the vertical rack profiles (12), a first level when the container rack (7) is in the lower position and a second level when the container rack (7) is in an access position, wherein the container supports may be fixed at least at the second level by mechanical stops or electronically controlled fasteners/brakes.

15. The storage system according to claim 1, wherein a first container support (8b) is arranged to support a first storage container (106b) at a first storage level and a second container support (8c) is arranged to support a second storage container (106c) at a second storage level, and the container rack (7) is configured such that a vertical distance between the first and the second container support (8b,8c) will increase when the container rack is moved from the lowest position to a container access position in which the first storage container (106b) may be retrieved from the first storage level by the container handling vehicle (301).

16. A method of improving access to a storage container in a storage system, the method comprising:
identifying the storage container (106) stored in one of multiple storage columns (105);
retrieving the storage container from the storage column by use of a container handling vehicle;
moving a container rack (7) to an access position, wherein a corresponding storage level is available;
moving the container handling vehicle to the container rack;
extending a cantilever section and a lifting frame of the container handling vehicle into the container rack (7); and
depositing the storage container at the available storage level.

17. A method of retrieving a storage container in a storage system, the method comprising:
identifying a container rack and storage level at which the storage container is stored;
moving the identified container rack (7) to a container access position, wherein the storage container is supported at the corresponding storage level;
moving a container handling vehicle to the container rack;
extending a cantilever section and a lifting frame of the container handling vehicle into the container rack (7); and
retrieving the storage container.
